(19) United States
(12) Patent Application Publication
(10) Pub. No.: US 2026/0145253 A1
(43) Pub. Date: May 28, 2026

(54) SLICING APPARATUS AND WIRE-ARRANGEMENT METHOD THEREOF

(71) Applicant: GlobalWafers Co., Ltd., Hsinchu City (TW)

(72) Inventors: KUO-CHEN HSU, Hsinchu City (TW); CHENG-CHIEN CHANG, Hsinchu (TW)

(21) Appl. No.: 19/362,627

(22) Filed: Oct. 20, 2025

(30) Foreign Application Priority Data
Nov. 22, 2024 (TW) 113144986

(51) Int. Cl. B23D 61/18; B65H 49/32; B65H 51/12; B65H 54/02

(52) U.S. Cl. CPC B23D 61/185; B65H 49/32; B65H 51/12; B65H 54/02; B65H 2557/24; B65H 2557/63; B65H 2701/36

(57) ABSTRACT

A slicing apparatus and a wire-arrangement method thereof. The wire-arrangement method includes: obtaining a standard position parameter from a standard reel that is assembled to a shaft for providing a wire-arrangement mechanism to define a predetermined winding start point and a predetermined winding end point on the standard reel; assembling a reel to the shaft and obtaining a real position parameter of the reel; using a processing device to obtain a position compensation parameter by comparing the standard position parameter and real position parameter for providing the wire-arrangement mechanism to respectively adjust the predetermined winding start point and the predetermined winding end point to become a real winding start point and a real winding end point; and using the wire-arrangement mechanism to wind a sawing wire around the reel from the real winding start point to the real winding end point.

### CROSS-REFERENCE TO RELATED PATENT APPLICATIONS

This application claims the benefit of priority to Taiwan Patent Application No. 113144986, filed on November 22, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a wire-slicing process, and more particularly to a slicing apparatus and a wire-arrangement method thereof.

### BACKGROUND OF THE DISCLOSURE

Sawing wire provided by sawing wire manufacturers is wound directly onto a reel. However, this can often give rise to several issues. If the sawing wire wound onto the reel is used directly with a conventional slicing equipment, there is a high probability for wire breakage to occur. For example, when the sawing wire wound onto the reel is provided by the sawing wire manufacturer, it often suffers from unstable wire quality and tolerance accumulation due to the inability of the wire winding process to adjust for component tolerances.

### SUMMARY OF THE DISCLOSURE

In response to the above-referenced technical inadequacies, the present disclosure provides a slicing apparatus and a wire-arrangement method thereof for effectively improving on the issues associated with a conventional slicing apparatus (e.g., reducing the difficulty and improving the re-arrangement frequency of pre-arrangement adjustment, and significantly reducing pre-arrangement operation time and wire breakage rate).

In order to solve the above-mentioned problems, one of the technical aspects adopted by the present disclosure is to provide a wire-arrangement method of a slicing apparatus, which includes a preparation step, a detection step, a compensation step, and a winding step. The preparation step is implemented by obtaining a standard position parameter from a standard reel that is assembled to a shaft. According to the standard position parameter, a wire-arrangement mechanism defines a predetermined winding start point and a predetermined winding end point on the standard reel. The detection step is implemented by assembling a reel to the shaft and obtaining a real position parameter of the reel. The compensation step is implemented by comparing the real position parameter and the standard position parameter to obtain a position compensation parameter through a processing device. According to the position compensation parameter, the wire-arrangement mechanism respectively adjusts the predetermined winding start point and the predetermined winding end point to be a real winding start point and a real winding end point. The winding step is implemented by using the wire-arrangement mechanism to wind a sawing wire onto the reel from the real winding start point to the real winding end point.

In one of the possible or preferred embodiments, in the preparation step, the sawing wire provided by being wound on the reel is adjusted to be wound on an intermediary reel, such that the reel has no sawing wire wound thereon. In the winding step, the wire-arrangement mechanism is operated to wind the sawing wire from the intermediary reel to the reel, and is operated to monitor tension of the sawing wire through a tension arm monitoring unit thereof.

In order to solve the above-mentioned problems, another one of the technical aspects adopted by the present disclosure is to provide a slicing apparatus, which includes a shaft, a standard reel, a reel, a wire-arrangement mechanism, a processing device, and a sawing wire. The standard reel and the reel are sequentially assembled to the shaft. The standard reel defines a standard position parameter when being assembled to the shaft, and the reel defines a real position parameter when being assembled to the shaft. The reel includes a winding segment, a front boundary segment being connected to one end of the winding segment and abutting against the shaft, and a rear boundary segment connected to another end of the shaft. The wire-arrangement mechanism is configured to define a predetermined winding start point and a predetermined winding end point on the standard reel according to the standard position parameter. The processing device is configured to compare the real position parameter and the predetermined position parameter to obtain a position compensation parameter. The wire-arrangement mechanism is configured to respectively adjust the predetermined winding start point and the predetermined winding end point to be a real winding start point and a real winding end point according to the position compensation parameter. The wire-arrangement mechanism is configured to wind the sawing wire onto the reel from the real winding start point to the real winding end point.

In one of the possible or preferred embodiments, the slicing apparatus further includes an intermediary reel corresponding in position to the reel. The sawing wire at an initial position is wound on the reel, and the sawing wire is configured to be transferred from the reel to the intermediary reel so as to be located at an intermediary position through the wire-arrangement mechanism. The wire-arrangement mechanism is configured to wind the sawing wire at the intermediary position onto the reel from the real winding start point to the real winding end point, so as to enable the sawing wire to be located at a real winding position. The wire-arrangement mechanism includes a tension arm monitoring unit that is configured to monitor tension of the sawing wire from the intermediary position to the real winding position.

Therefore, the slicing apparatus and the wire-arrangement method of the present disclosure can provide a standardized wire-arrangement process to effectively reduce an operation time of wire-arrangement. Furthermore, the reel and the sawing wire wound thereon obtained after implementing the wire-arrangement method can effectively eliminate (or compensate for) the differences between the reel and the standard reel, thereby avoiding the continuous accumulation of tolerances of the sawing wire during the wire-arrangement process, resulting in poor wire-arrangement quality. In other words, the reel and the sawing wire wound thereon obtained after implementing the wire-arrangement method can effectively reduce the probability of wire breakage when directly used in a slicing process (or the slicing apparatus).

Moreover, the slicing apparatus and the wire-arrangement method of the present disclosure can further effectively improve the issues that may arise from the poor winding capabilities of sawing wire manufacturers. In addition, the wire-arrangement mechanism can further include a tension arm monitoring unit that is configured to monitor tension of the sawing wire from the intermediary position to the real winding position, thereby effectively detecting abnormalities before the slicing apparatus begins production and further providing an off-line alarm mechanism.

These and other aspects of the present disclosure will become apparent from the following description of the embodiment taken in conjunction with the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a wire-arrangement method of a slicing apparatus according to one embodiment of the present disclosure;

FIG. 2 is a schematic view showing a preparation step that is implemented to assemble a standard reel;

FIG. 3 is a schematic view showing a subsequent operation from FIG. 2;

FIG. 4 is a schematic view showing a standard position parameter corresponding to a standard reel;

FIG. 5 and FIG. 6 are schematic views showing a detection step of FIG. 1;

FIG. 7 is a schematic view showing a real position parameter corresponding to the detection step and a compensation step of FIG. 1;

FIG. 8 and FIG. 9 are schematic views showing a winding step of FIG. 1; and

FIG. 10 is a functional block diagram of the slicing apparatus according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### Wire-Arrangement Method of Slicing Apparatus

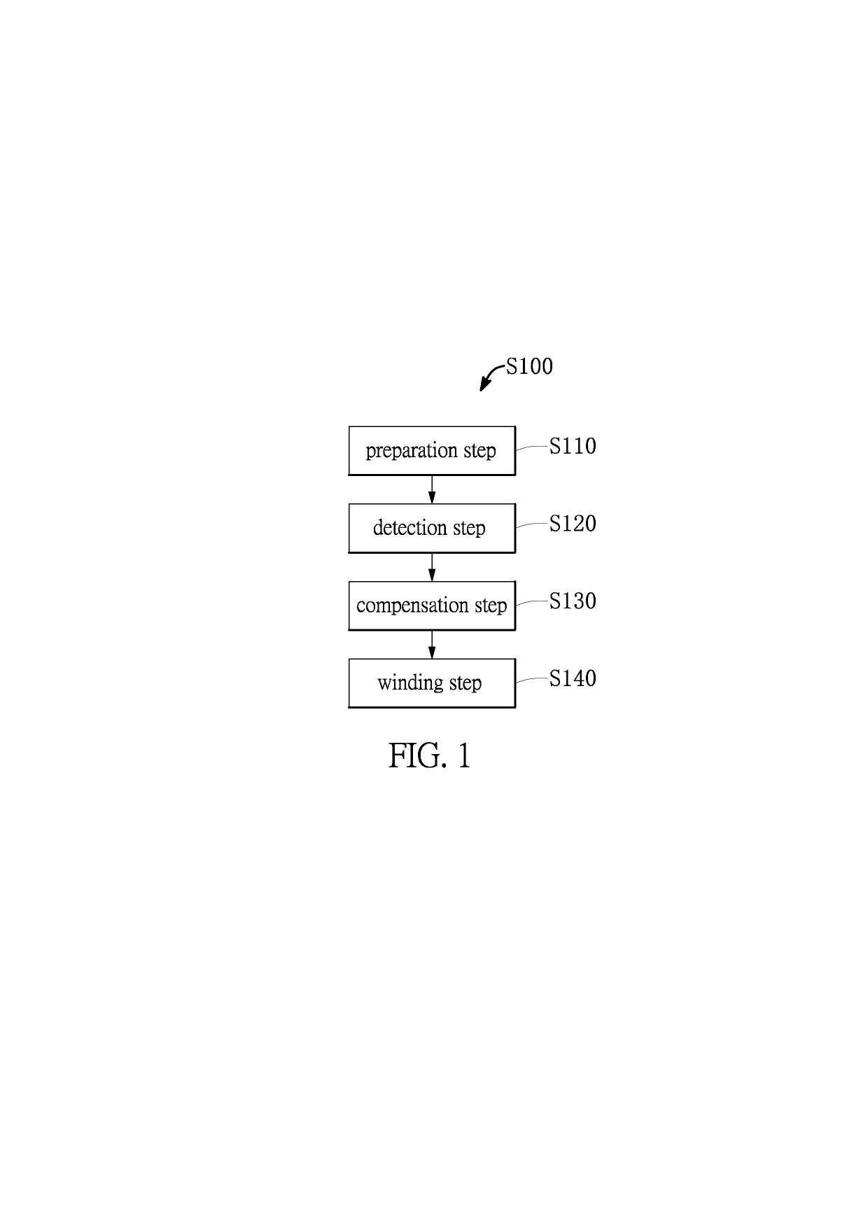

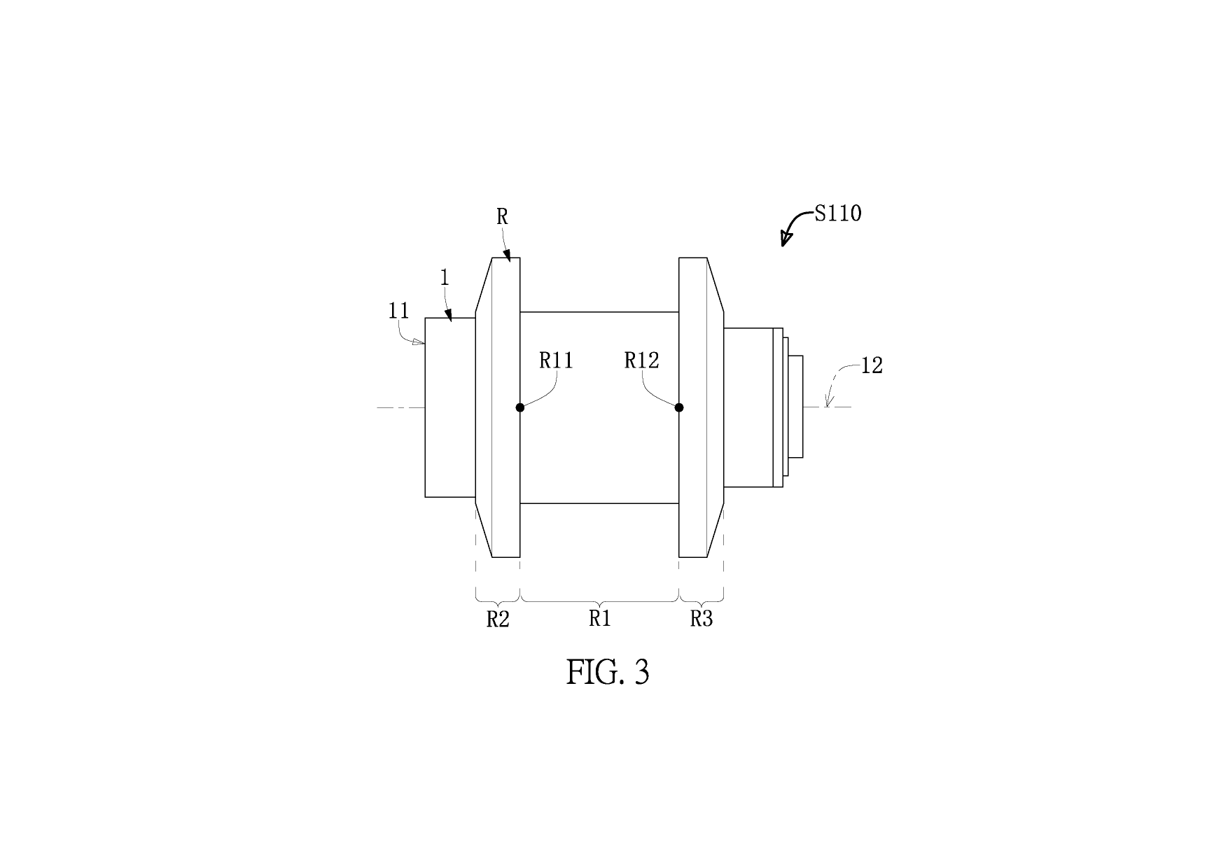

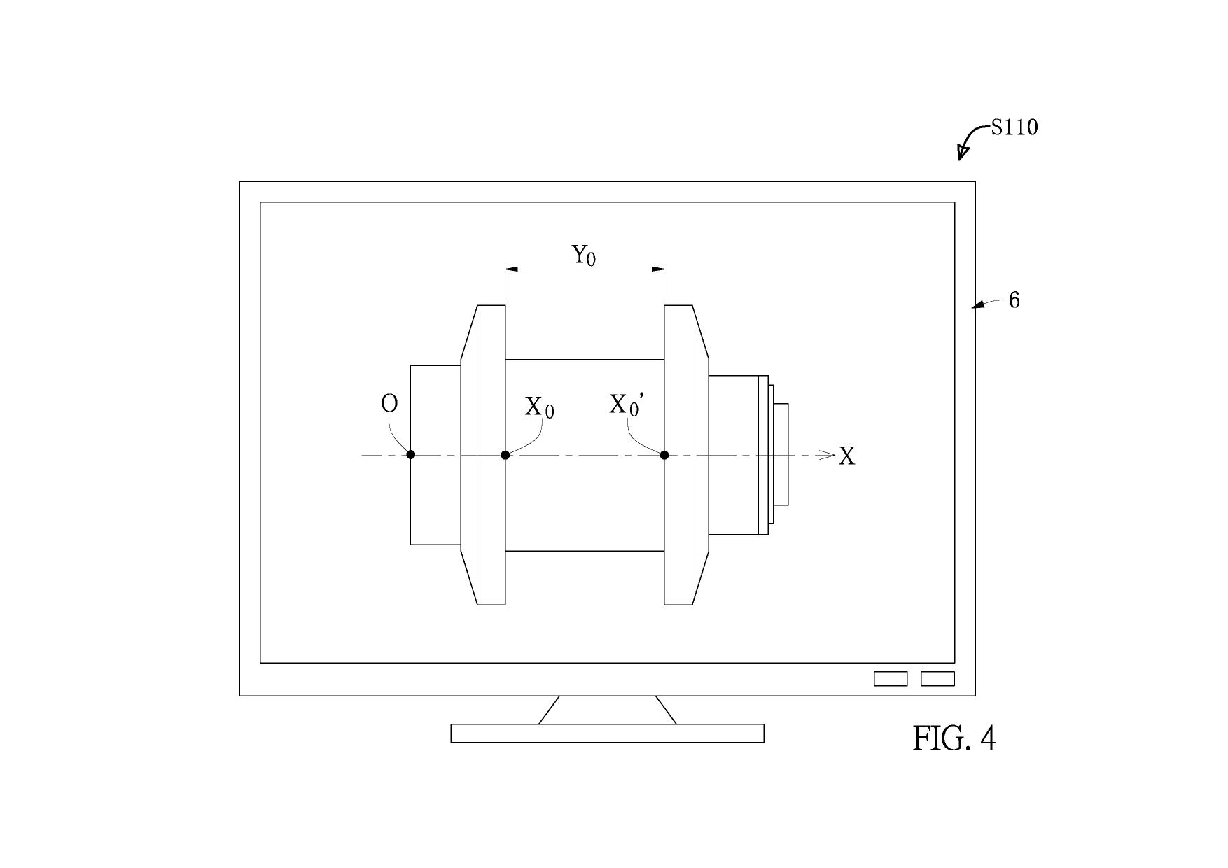

Referring to FIG. 1 to FIG. 10, an embodiment of the present disclosure is provided. The present embodiment provides a slicing apparatus 100 and a wire-arrangement method S100 thereof, which can be applied to a slicing process in a semiconductor field or a solar energy field. For example, the slicing apparatus 100 and the wire-arrangement method S100 can be applied to the slicing process for a silicon carbide (SiC) wafer, but the present disclosure is not limited thereto.

In order to clearly describe the present embodiment, the following description describes the wire-arrangement method S100, and then describes the slicing apparatus 100. As shown in FIG. 1, the wire-arrangement method S100 in the present embodiment sequentially includes (or performs): a preparation step S110, a detection step S120, a compensation step S130, and a winding step S140. The following description describes a specific implementation of each of the above steps, and parameters of each of the above steps can be obtained and calculated by corresponding devices (e.g., a camera device and a calculating device) that are not described herein.

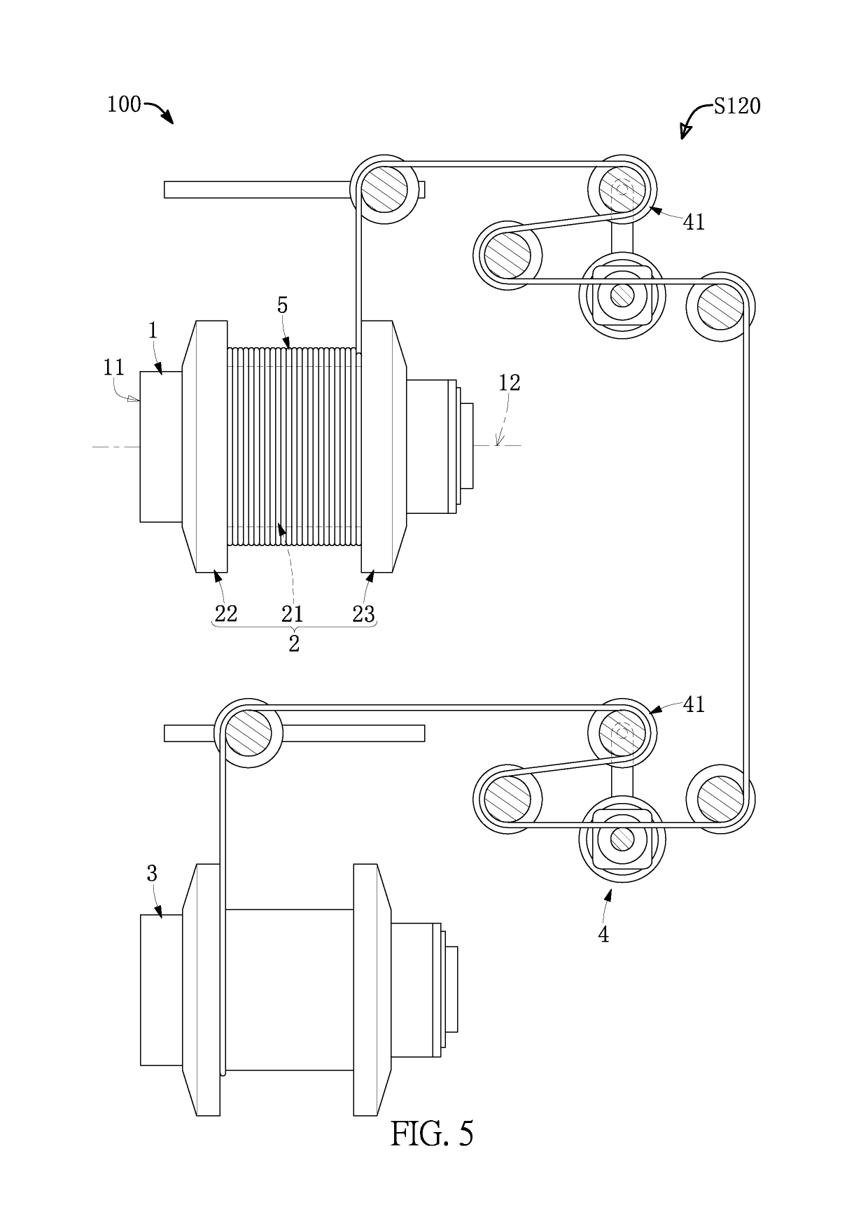

As shown in FIG. 1 to FIG. 4, the preparation step S110 is implemented by obtaining a standard position parameter from a standard reel R that is assembled to a shaft 1. According to the standard position parameter, a wire-arrangement mechanism 4 (as shown in FIG. 5) defines a predetermined winding start point R11 and a predetermined winding end point R12 on the standard reel R.

Specifically, the standard reel R in the present embodiment has a standard winding segment R1, a standard front boundary segment R2 that abuts against the shaft 1 and that is connected to one end of the standard winding segment R1, and a standard rear boundary segment R3 that is connected to another end of the standard winding segment R1. The standard winding segment R1 is substantially cylindrical, the standard front boundary segment R2 and the standard rear boundary segment R3 have a substantially same diameter that is greater than a diameter of the standard winding segment R1.

It should be noted that specific implementation of the standard position parameter and a corresponding parameter (e.g., a real position parameter disclosed in the following description) can be adjusted or changed according to design requirements and is presented by using coordinate comparison in the following description, but the present disclosure is not limited thereto. For example, in other embodiments of the present disclosure not shown in the drawings, the specific implementations of the standard position parameter and the corresponding parameter can be presented by using an image comparison.

In the present embodiment, the standard position parameter includes a standard start point X₀, a standard end point X₀’, and a standard length Y₀. The standard start point X₀ corresponds to (or is mapped by) the one end of the standard winding segment R1 and corresponds (or is mapped by) to the predetermined winding start point R11. The standard end point X₀’ corresponds to (or is mapped by) the another end of the standard winding segment R1 and corresponds to (or is mapped by) the predetermined winding end point R12. The standard length Y₀ corresponds to (or is mapped by) the standard winding segment R1.

Specifically, a central line 12 of the shaft 1 defines (or is mapped to) a transverse coordinate axis X having an origin O. In the present embodiment, a left lateral surface of the shaft 1 is defined as a reference surface 11 that defines (or is mapped to) the original O, and position of the reference surface 11 can be adjusted or changed according to design requirements and is not limited by the present embodiment. Moreover, the standard start point X₀ corresponds to (or is defined as) a standard start point coordinate of the transverse coordinate axis X, the standard end point X₀’corresponds to (or is defined as) a standard end point coordinate of the transverse coordinate axis X, and the standard length Y₀ is equivalent to a difference between the standard start point X₀ and the standard end point X₀’. In addition, before implementing a following step, the standard reel R is removed from the shaft 1.

As shown in FIG. 5 to FIG. 7, the detection step S120 is implemented by assembling a reel 2 to the shaft 1 and obtaining a real position parameter of the reel 2. In the present embodiment, the reel 2 has a winding segment 21, a front boundary segment 22 that abuts against the shaft 1 and that is connected to one end of the winding segment 21, and a rear boundary segment 23 that is connected to another end of the winding segment 21. The winding segment 21 is substantially cylindrical, the front boundary segment 22 and the rear boundary segment 23 have a substantially same diameter that is greater than a diameter of the winding segment 21.

Specifically, the real position parameter includes a real start point X₁, a real end point X₁’, and a real length Y₁. The real start point X₁corresponds to (or is mapped by) the one end of the winding segment 21 and corresponds to (or is mapped by) to the real winding start point coordinate of the transverse coordinate axis X. The real end point X₁’ corresponds to (or is mapped by) the another end of the winding segment 21 and corresponds to (or is mapped by) the real winding end point coordinate of the transverse coordinate axis X. The real length Y₁ corresponds to (or is mapped by) the winding segment 21 and is equivalent to a difference between the real start point X₁ and the real end point X₁’.

It should be noted that the reel 2 in the present embodiment is provided by being wound with a sawing wire 5, so that the preparation step S110 is further implemented by using the wire-arrangement mechanism 4 to adjust the sawing wire 5 to be wound on an intermediary reel 3 from the reel 2 for enabling the reel 2 to have no sawing wire wound thereon, but the present disclosure is not limited thereto. For example, in other embodiments of the present disclosure not shown in the drawings, the reel 2 can be provided without any sawing wire wound thereon according to design requirements, such that the intermediary reel 3 can be omitted.

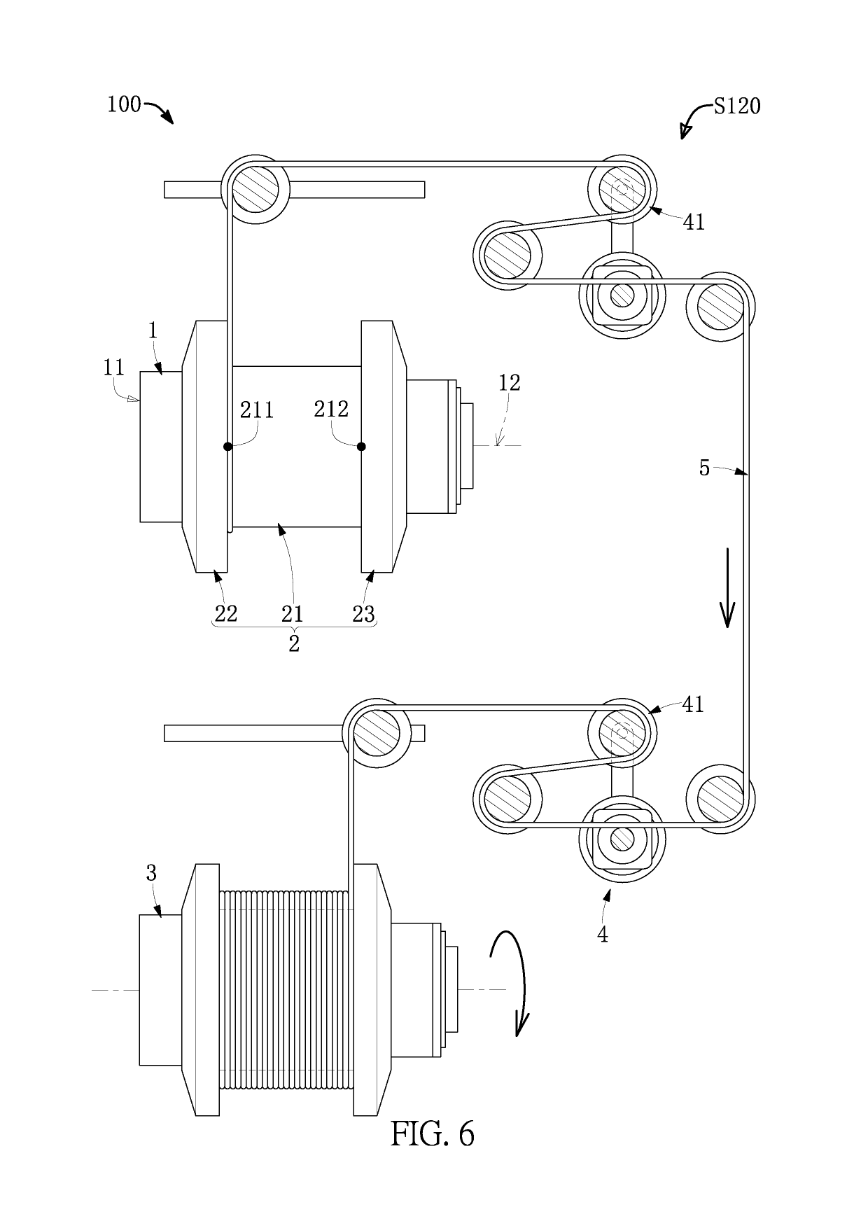

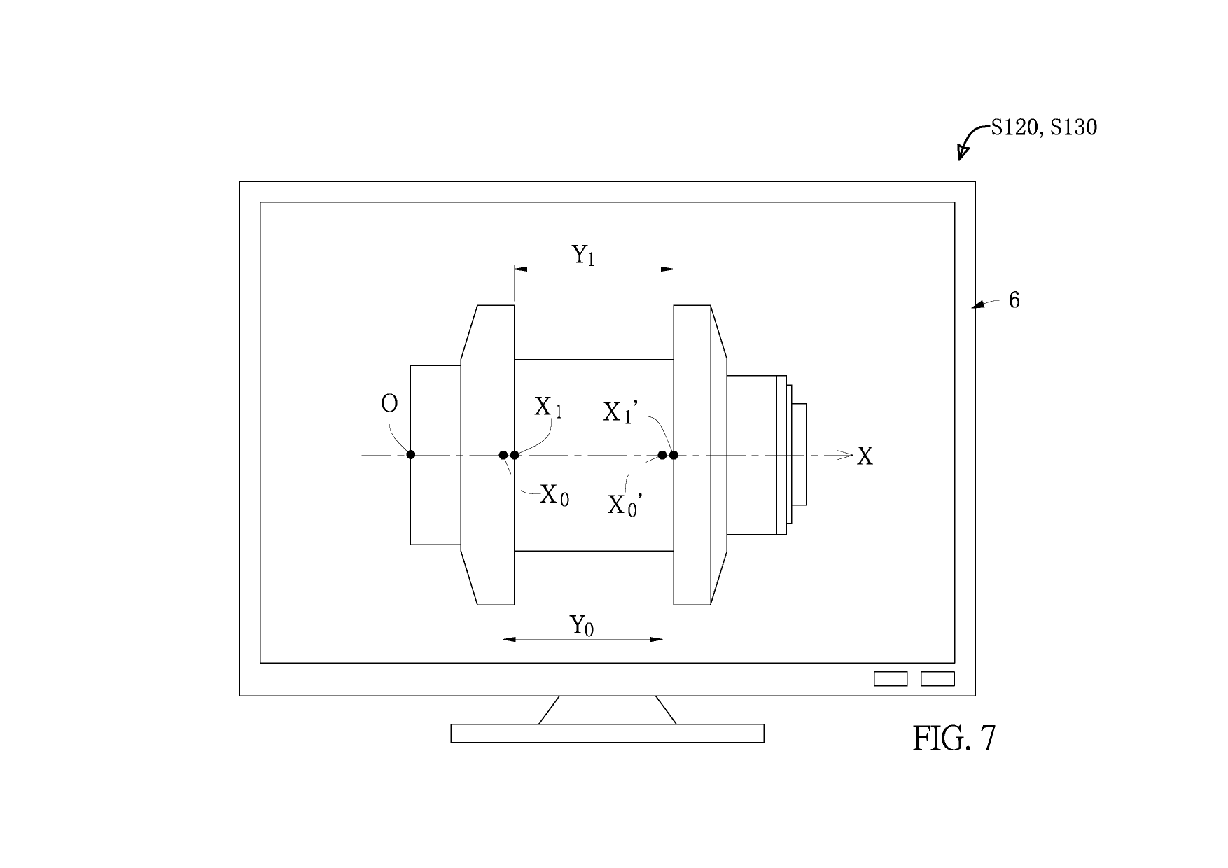

As shown in FIG. 6 and FIG. 7, the compensation step S130 is implemented by comparing the real position parameter and the standard position parameter to obtain a position compensation parameter through a processing device 6. Moreover, according to the position compensation parameter, the wire-arrangement mechanism 4 respectively adjusts the predetermined winding start point R11 and the predetermined winding end point R12 to be a real winding start point 211 and a real winding end point 212.

Specifically, the processing device 6 can be an instrument (e.g., a computer) with computing function, and the position compensation parameter obtained by the processing device 6 includes a start compensation value and an end compensation value. Moreover, the wire-arrangement mechanism 4 adjusts the predetermined winding start point R11 to be the real winding start point 211 according to the start compensation value, and the wire-arrangement mechanism 4 adjusts the predetermined winding end point R12 to be the real winding end point 212 according to the end compensation value.

It should be noted that a specific calculation manner of the start compensation value and the end compensation value can be changed according to design requirements. In the present embodiment, the start compensation value and the end compensation value can meet the following conditions for enabling the wire-arrangement mechanism 4 to more accurately establish the real winding start point 211 and the real winding end point 212. The start compensation value is (X₁-X₀)-(Y₁-Y₀)/2, and the end compensation value that is (X₁-X₀)+(Y₁-Y₀)/2, but the present disclosure is not limited thereto. For example, the start compensation value can be a difference between the standard start point X₀ and the real start point X₁, and the end compensation value can be a difference between the standard end point X₀’ and the real end point X₁’.

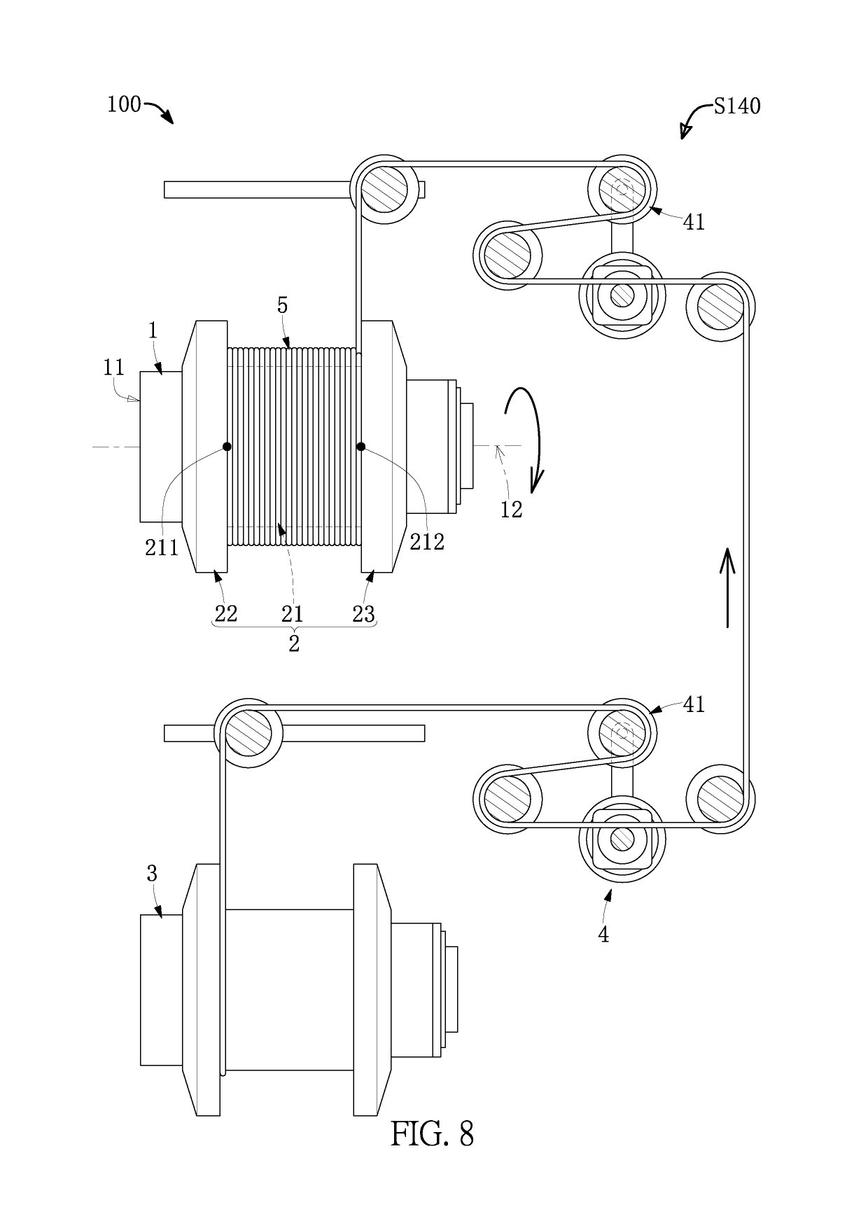

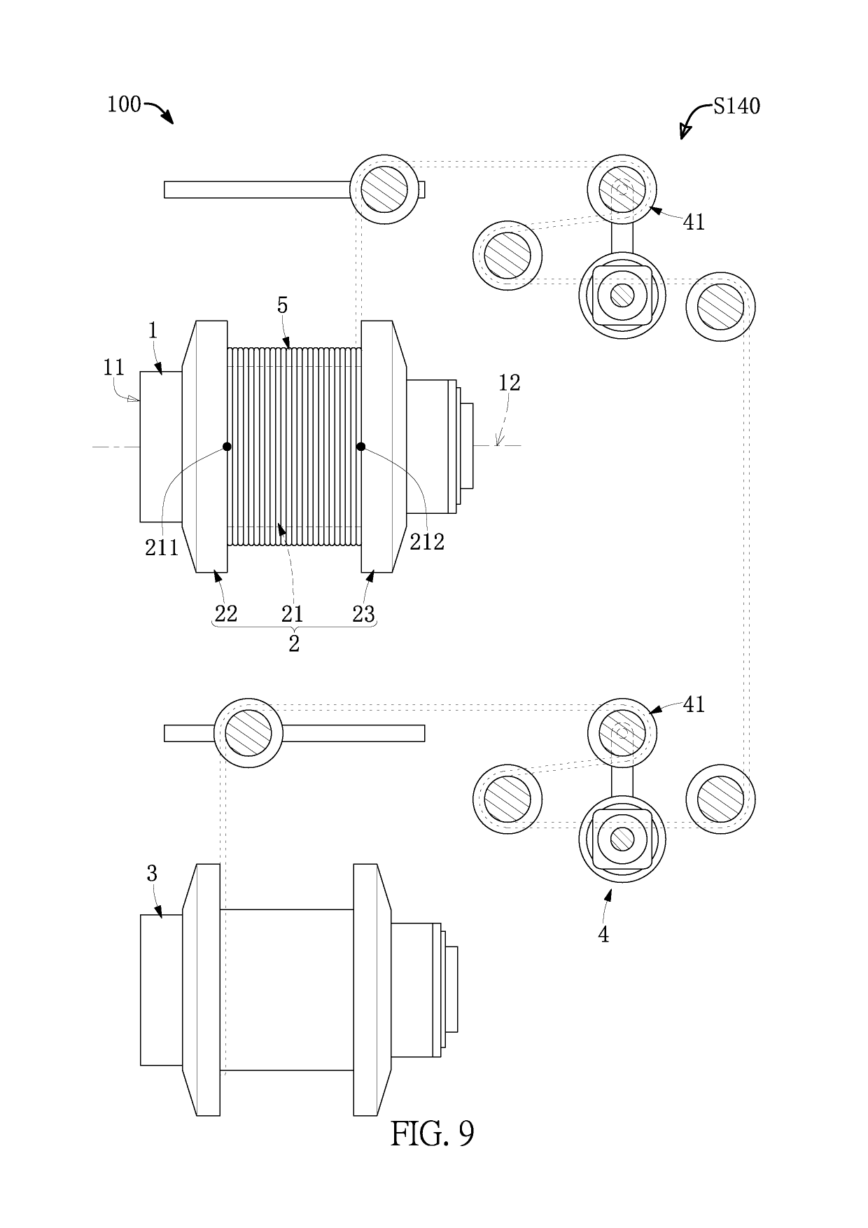

As shown in FIG. 8 and FIG. 9, the winding step S140 is implemented by using the wire-arrangement mechanism 4 to wind the sawing wire 5 onto the reel 2 (e.g., the winding segment 21) from the real winding start point 211 to the real winding end point 212. In the present embodiment, the wire-arrangement mechanism 4 is operated to wind the sawing wire 5 from the intermediary reel 3 to the reel 2 (e.g., the winding segment 21), and is operated to monitor tension of the sawing wire 5 through a tension arm monitoring unit 41 thereof.

In summary, the wire-arrangement method S100 in the present embodiment provides a standardized wire-arrangement process to effectively reduce an operation time of wire-arrangement. The reel 2 and the sawing wire 5 wound thereon obtained after implementing the wire-arrangement method S100 can effectively eliminate (or compensate for) the differences between the reel 2 and the standard reel R, thereby avoiding the continuous accumulation of tolerances of the sawing wire 5 during the wire-arrangement process, resulting in poor wire-arrangement quality. In other words, the reel 2 and the sawing wire 5 wound thereon obtained after implementing the wire-arrangement method S100 can effectively reduce the probability of wire breakage when directly used in a slicing process (or the slicing apparatus 100).

### Slicing Apparatus

The above description describes the wire-arrangement method S100, and the following description substantially describes the slicing apparatus 100 configured to implement the wire-arrangement method S100, so that technical features of the slicing apparatus 100 can be referred to in the above description of the wire-arrangement method S100, but the present disclosure is not limited thereto. For example, in other embodiments of the present disclosure not shown in the drawings, the slicing apparatus 100 can be configured to implement a method other than the wire-arrangement method S100.

As shown in FIG. 5 to FIG. 10, the slicing apparatus 100 in the present embodiment includes a shaft 1, a reel 2 assembled to the shaft 1, an intermediary reel 3 corresponding in position to the reel 2, a wire-arrangement mechanism 4 arranged between the reel 2 and the intermediary reel 3, and a sawing wire 5, but the present disclosure is not limited thereto. For example, in other embodiments of the present disclosure not shown in the drawings, the intermediary reel 3 of the slicing apparatus 100 can be omitted or can be replaced by other components according to design requirements.

The reel 2 is detachably sleeved at the shaft 1, and the reel 2 has a winding segment 21, a front boundary segment 22 that abuts against the shaft 1 and that is connected to one end of the winding segment 21, and a rear boundary segment 23 that is connected to another end of the winding segment 21. The winding segment 21 is substantially cylindrical, the front boundary segment 22 and the rear boundary segment 23 have a substantially same diameter that is greater than a diameter of the winding segment 21.

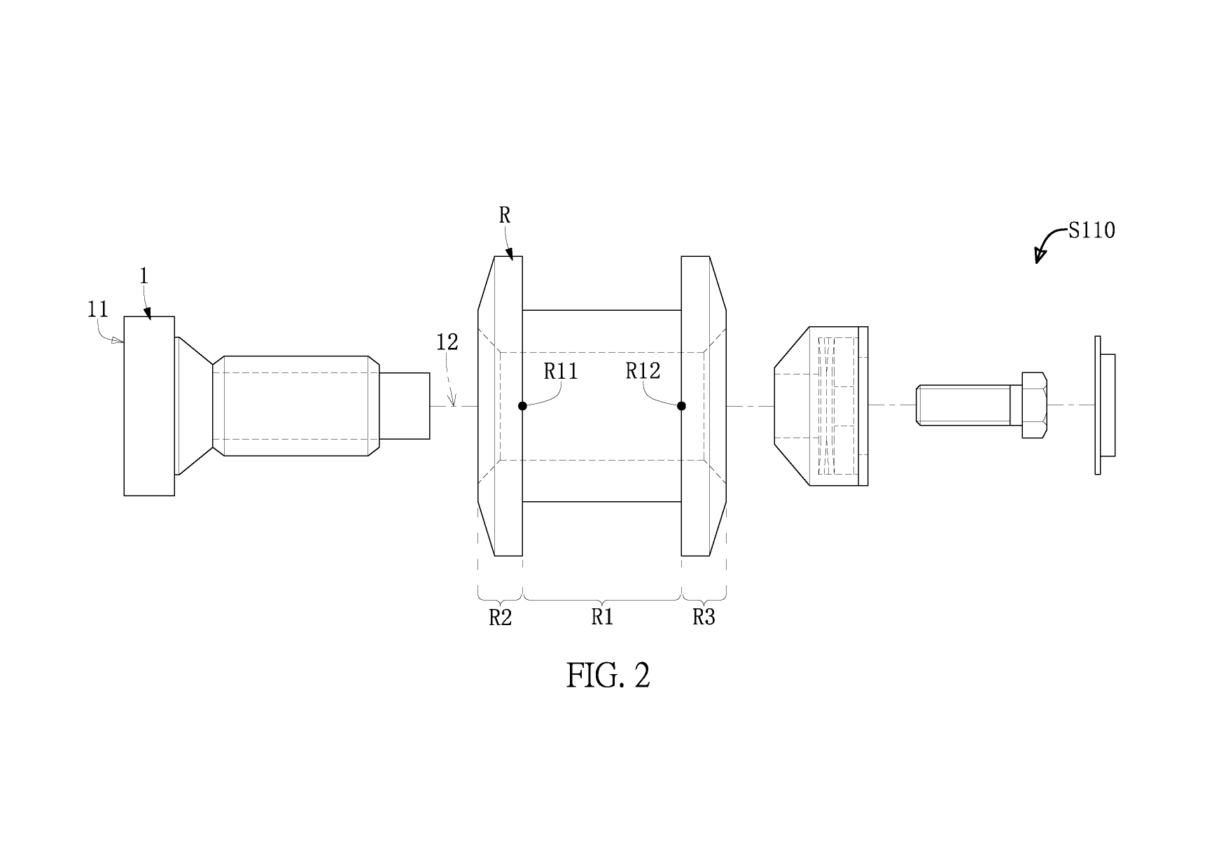

The wire-arrangement mechanism 4 has a predetermined winding start point R11 and a predetermined winding end point R12 that correspond to the standard reel R (as shown in FIG. 2). The wire-arrangement mechanism 4 is configured to adjust the predetermined winding start point R11 to be a real winding start point 211 according to the one end of the winding segment 21, and is configured to adjust the predetermined winding end point R12 to be a real winding end point 212 according to the another end of the winding segment 21. Furthermore, the wire-arrangement mechanism 4 is configured to wind the sawing wire 5 onto the reel 2 from the real winding start point 211 to the real winding end point 212.

Specifically, the sawing wire 5 in the present embodiment is provided by being wound on the reel 2 to be located at an initial position (as shown in FIG. 5), and the sawing wire 5 is configured to be transferred from the reel 2 to the intermediary reel 3 so as to be located at an intermediary position (as shown in FIG. 6) through the wire-arrangement mechanism 4. Moreover, the wire-arrangement mechanism 4 is configured to wind the sawing wire 5 at the intermediary position onto the reel 2 from the real winding start point 211 to the real winding end point 212, so as to enable the sawing wire 5 to be located at a real winding position (as shown in FIG. 9).

It should be noted that the wire-arrangement mechanism 4 in the present embodiment further includes a tension arm monitoring unit 41 that is configured to monitor tension of the sawing wire 5 from the intermediary position to the real winding position, thereby effectively detecting abnormalities before the slicing apparatus 100 begins production and further providing an off-line alarm mechanism. The tension arm monitoring unit 41 in the present embodiment includes two tension swing arms and corresponding structures, and the tension arm monitoring unit 41 can monitor the tension of the sawing wire 5 by detecting an angle of any one of the two tension swing arms, but the present disclosure is not limited thereto. For example, in other embodiments of the present disclosure not shown in the drawings, the tension arm monitoring unit 41 can include different components (e.g., one tension swing arm and corresponding structures) according to design requirements.

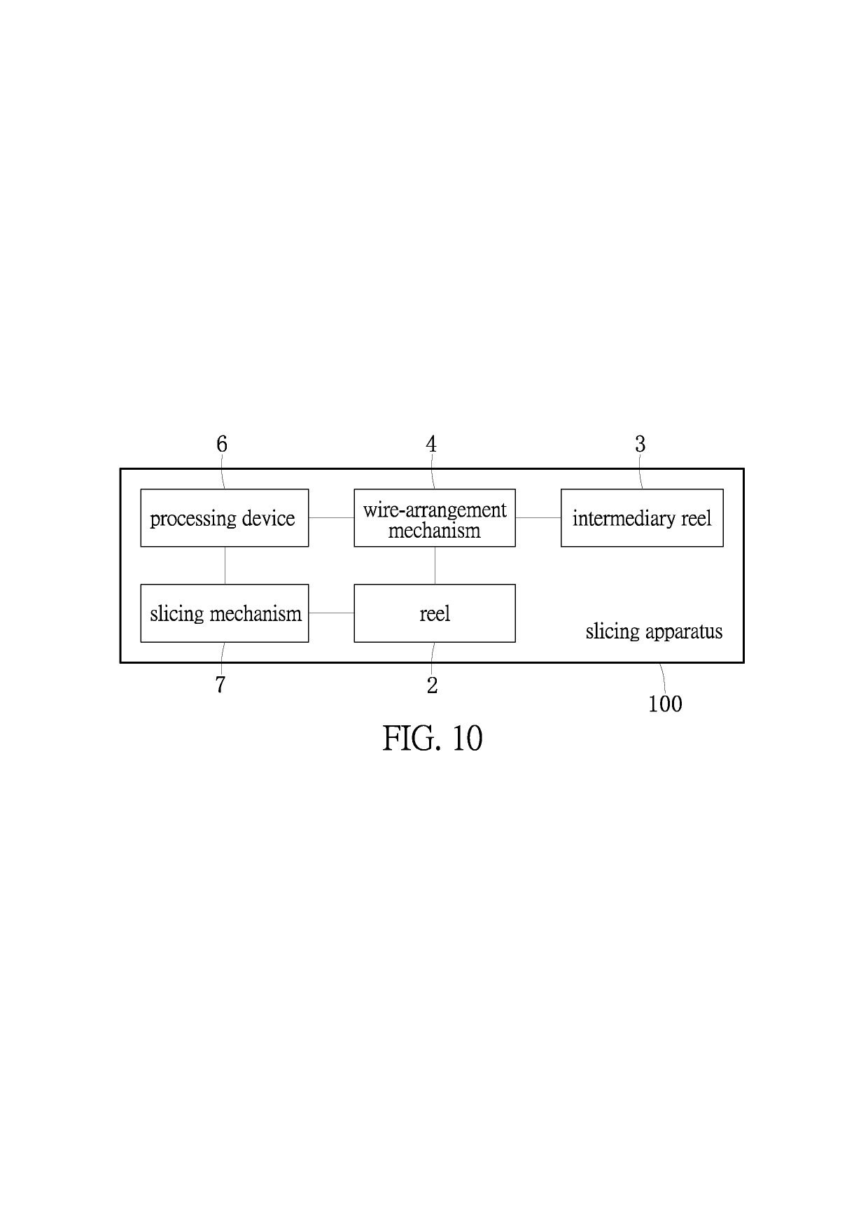

Moreover, as shown in FIG. 10, the slicing apparatus 100 further includes a slicing mechanism 7, and the sawing wire 5 at the real winding position can be wound onto the slicing mechanism 7 for a slicing process. In addition, the slicing mechanism 7 can be provided in any configuration according to design requirements, and is not limited by the present embodiment.

### Beneficial Effects of the Embodiment

In conclusion, the slicing apparatus and the wire-arrangement method of the present disclosure can provide a standardized wire-arrangement process to effectively reduce an operation time of wire-arrangement. Furthermore, the reel and the sawing wire wound thereon obtained after implementing the wire-arrangement method can effectively eliminate (or compensate for) the differences between the reel and the standard reel, thereby avoiding the continuous accumulation of tolerances of the sawing wire during the wire-arrangement process, resulting in poor wire-arrangement quality. In other words, the reel and the sawing wire wound thereon obtained after implementing the wire-arrangement method can effectively reduce the probability of wire breakage when directly used in a slicing process (or the slicing apparatus).

Moreover, the slicing apparatus and the wire-arrangement method of the present disclosure can further effectively improve the issues that may arise from the poor winding capabilities of sawing wire manufacturers. In addition, the wire-arrangement mechanism can further include a tension arm monitoring unit that is configured to monitor tension of the sawing wire from the intermediary position to the real winding position, thereby effectively detecting abnormalities before the slicing apparatus begins production and further providing an off-line alarm mechanism.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A wire-arrangement method of a slicing apparatus, comprising:
a preparation step implemented by obtaining a standard position parameter from a standard reel that is assembled to a shaft, wherein, according to the standard position parameter, a wire-arrangement mechanism defines a predetermined winding start point and a predetermined winding end point on the standard reel;
a detection step implemented by assembling a reel to the shaft and obtaining a real position parameter of the reel;
a compensation step implemented by comparing the real position parameter and the standard position parameter to obtain a position compensation parameter through a processing device, wherein, according to the position compensation parameter, the wire-arrangement mechanism respectively adjusts the predetermined winding start point and the predetermined winding end point to be a real winding start point and a real winding end point; and
a winding step implemented by using the wire-arrangement mechanism to wind a sawing wire onto the reel from the real winding start point to the real winding end point.

2. The wire-arrangement method according to claim 1, wherein the standard reel has a standard winding segment, a standard front boundary segment connected to one end of the standard winding segment, and a standard rear boundary segment that is connected to another end of the standard winding segment, and wherein the standard front boundary segment abuts against the shaft, and the standard position parameter includes:
a standard start point corresponding to the one end of the standard winding segment and corresponding to the predetermined winding start point; and
a standard end point corresponding to the another end of the standard winding segment and corresponding to the predetermined winding end point.

3. The wire-arrangement method according to claim 2, wherein the reel has a winding segment, a front boundary segment connected to one end of the winding segment, and a rear boundary segment that is connected to another end of the winding segment, wherein the front boundary segment abuts against the shaft, and the real position parameter includes a real start point corresponding to the one end of the winding segment, and wherein, in the compensation step, the position compensation parameter obtained by the processing device includes a start compensation value that is a difference between the standard start point and the real start point, and the wire-arrangement mechanism adjusts the predetermined winding start point to be the real winding start point according to the start compensation value.

4. The wire-arrangement method according to claim 3, wherein a central line of the shaft defines a transverse coordinate axis having an origin, the standard start point corresponds to a standard start point coordinate of the transverse coordinate axis that is defined as X₀, and the real start point corresponds to a real start point coordinate of the transverse coordinate axis that is defined as X₁.

5. The wire-arrangement method according to claim 4, wherein the standard position parameter includes a standard length that corresponds to the standard winding segment and that is defined as Y₀, the real position parameter includes a real length that corresponds to the winding segment and that is defined as Y₁, the start compensation value is (X₁-X₀)-(Y₁-Y₀)/2, and the position compensation parameter includes an end compensation value that is (X₁-X₀)+(Y₁-Y₀)/2, and wherein the wire-arrangement mechanism adjusts the predetermined winding end point to be the real winding end point according to the end compensation value.

6. The wire-arrangement method according to claim 3, wherein the real position parameter includes a real end point corresponding to the another end of the reel, and wherein, in the compensation step, the position compensation parameter obtained by the processing device includes an end compensation value that is a difference between the standard end point and the real end point, and the wire-arrangement mechanism adjusts the predetermined winding end point to be the real winding end point according to the end compensation value.

7. The wire-arrangement method according to claim 6, wherein a central line of the shaft defines a transverse coordinate axis having an origin, the standard end point corresponds to a standard end point coordinate of the transverse coordinate axis, and the real end point corresponds to a real end point coordinate of the transverse coordinate axis.

8. The wire-arrangement method according to claim 1, wherein, in the preparation step, the sawing wire provided by being wound on the reel is adjusted to be wound on an intermediary reel, such that the reel has no sawing wire wound thereon, and wherein, in the winding step, the wire-arrangement mechanism is operated to wind the sawing wire from the intermediary reel to the reel, and is operated to monitor tension of the sawing wire through a tension arm monitoring unit thereof.

9. A slicing apparatus, comprising:
a shaft;
a standard reel and a reel that are sequentially assembled to the shaft, wherein the standard reel defines a standard position parameter when being assembled to the shaft, and the reel defines a real position parameter when being assembled to the shaft, and wherein the reel includes:
a winding segment;
a front boundary segment being connected to one end of the winding segment and abutting against the shaft; and
a rear boundary segment connected to another end of the shaft;
a wire-arrangement mechanism configured to define a predetermined winding start point and a predetermined winding end point on the standard reel according to the standard position parameter;
a processing device is configured to compare the real position parameter and the predetermined position parameter to obtain a position compensation parameter, wherein the wire-arrangement mechanism is configured to respectively adjust the predetermined winding start point and the predetermined winding end point to be a real winding start point and a real winding end point according to the position compensation parameter; and
a sawing wire, wherein the wire-arrangement mechanism is configured to wind the sawing wire onto the reel from the real winding start point to the real winding end point.

10. The slicing apparatus according to claim 9, further comprising an intermediary reel corresponding in position to the reel, wherein the sawing wire at an initial position is wound on the reel, and the sawing wire is configured to be transferred from the reel to the intermediary reel so as to be located at an intermediary position through the wire-arrangement mechanism, wherein the wire-arrangement mechanism is configured to wind the sawing wire at the intermediary position onto the reel from the real winding start point to the real winding end point so as to enable the sawing wire to be located at a real winding position, and wherein the wire-arrangement mechanism includes a tension arm monitoring unit that is configured to monitor tension of the sawing wire from the intermediary position to the real winding position.
